(19) United States
(12) Patent Application Publication
(10) Pub. No.: US 2018/0106048 A1
(43) Pub. Date: Apr. 19, 2018

(54) BUILDING PRODUCT DISPLAY SYSTEMS AND METHODS

(71) Applicant: NEWTONOID TECHNOLOGIES, L.L.C., Liberty, MO (US)

(72) Inventors: FIELDING B. STATON, LIBERTY, MO (US); DAVID STRUMPF, COLUMBIA, MO (US)

(21) Appl. No.: 15/787,646

(22) Filed: Oct. 18, 2017

Related U.S. Application Data
(60) Provisional application No. 62/409,609, filed on Oct. 18, 2016.

(51) Int. Cl. E04F 13/072; G05B 15/02; E06B 9/38

(52) U.S. Cl. CPC E04F 13/072; G05B 2219/2642; E06B 9/38; G05B 15/02

(57) ABSTRACT

A distributed communications system comprises a substrate coated with a coating comprising a plurality of particles dispersed therein, the particles being tunable in response to an electric field applied to the substrate; a sensor distributed near the substrate; and a central hub in communication with the sensor and the substrate. The central hub is embodied in a computer structure having non-transitory computer readable medium with computer executable instructions stored thereon executed by a digital processor to analyze data received by the sensor, determine a magnitude of the electric field based on the data received by the sensor; and activate the electric field.

### CROSS-REFERENCE TO RELATED APPLICATIONS

This application claims priority to U.S. Provisional Patent Application No. 62/409,609, filed Oct. 18, 2016, the entirety of which is incorporated by reference herein.

### BACKGROUND

In today's world, nearly every device is programmable to function for both its intended purpose, as well as ancillary purposes that allegedly make one's life simpler. For example, cell phones are used not only for telephoning others, but can be used as a remote to control the television, set the security alarm or thermostat, and as small computer, among other things. While other devices have recognized substantial advances in technology, the technology surrounding automatic control of building function has remained relatively flat. This is true even though separately, many subsystems in a building or building(s) are able to be remotely controlled.

Many systems located within a building (e.g., HVAC, alarms, etc.) have “smart” telecommunication capabilities which allow the inhabitants of the building to communicate with the systems, even from remote locations, through their personal devices to control the smart systems. Building products (e.g., siding, sheet rock, flooring, wall coverings, etc.) are used in the structure of nearly every building in the world. However, the building itself, via the products that form the structure, is “dumb”—in other words, it is incapable of communicating with the systems therein, or even other buildings.

It would be desirable for building products to have smart sensory and communication capabilities that may allow for a controlled response by the building products and/or one or more systems located within the building, or another building in a remote location.

### SUMMARY

The following presents a simplified summary of the invention in order to provide a basic understanding of some aspects of the invention. This summary is not an extensive overview of the invention. It is not intended to identify critical elements of the invention or to delineate the scope of the invention. Its sole purpose is to present some concepts of the invention in a simplified form as a prelude to the more detailed description that is presented elsewhere herein.

In one embodiment, a distributed communications system comprises a substrate coated with a coating comprising a plurality of particles dispersed therein, the particles being tunable in response to an electric stimulus applied to the substrate; a sensor distributed near the substrate; and a central hub in communication with the sensor and the substrate. The central hub is embodied in a computer structure having non-transitory computer readable medium with computer executable instructions stored thereon executed by a digital processor to analyze data received by the sensor, determine a magnitude of the electric stimulus based on the data received by the sensor; and activate the electric stimulus.

In another embodiment, a distributed communications system includes a substrate; a sensor on the substrate; and a central hub in communication with the sensor and the substrate. The central hub is embodied in a computer structure having non-transitory computer readable medium with computer executable instructions stored thereon executed by a digital processor to analyze data received by the sensor relating to a change of a property of the substrate; and provide an output to effectuate a change in a property of the substrate.

In still another embodiment, a distributed communications system includes a central hub in communication with a sensor disposed at a first location, and a building operating system disposed at a second location. The central hub is embodied in a computer structure having non-transitory computer readable medium with computer executable instructions stored thereon executed by a digital processor to: analyze data received by the sensor of environmental conditions at a first time at the first location; make a prediction of environmental conditions at a second time at the second location; and activate a response by the building operating system according to the prediction. The first location and the second location are not within a single structure.

### BRIEF DESCRIPTION OF THE DRAWINGS

FIG. 1 is a schematic representation of a distributed communication system in accordance with an embodiment of the invention.

FIG. 2 is a schematic illustration of a central hub of the distributed communication system of FIG. 1 in accordance with an embodiment of the invention.

FIG. 3 is a side view of a piece of siding.

FIG. 4A is a front view of the piece of siding of FIG. 3.

FIG. 4B is a rear view of the piece of siding of FIG. 3.

FIG. 5 is a schematic illustration of a building having a plurality of electrical leads disposed thereon.

### DETAILED DESCRIPTION

Distributed communications systems may be incorporated throughout a building for the purpose of providing seamless management thereof. Various traditional operational systems within a building (e.g., HVAC systems, lighting, etc.), as well as systems which have not been traditionally considered part of the “operational” components of a building (e.g., blinds, alarm systems, etc.) can be programmed to be responsive to changes in the building environment. Often, a building's environment is limited to what is happening inside. However, distributed communications may now also include non-traditional building components, such as siding, located on the outside of the building.

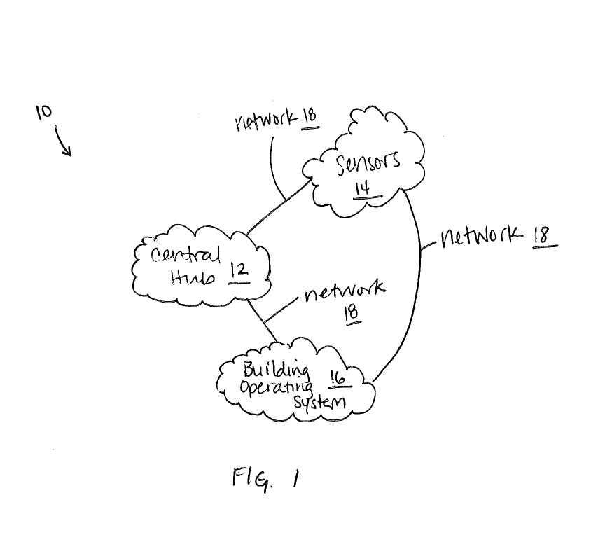

One of the many goals of the invention is to allow sensors in or on one or more buildings (or environments) to communicate automatically with a central hub to gather information and/or control operation of components of the building, as well as to allow a user to control operation when desirable. A schematic illustration of a system 10 is illustrated in FIG. 1, which shows a central hub 12 in communication with various sensors 14 and building operating systems 16 over a network 18. The sensors 14 may optionally also be in direct communication with the building operating system 16 over the network 18. Four distinct sub-systems may provide the means for operation of components within the system 10. A power sub-system may provide the necessary electrical requirements to allow each of the smart components to function; a communications sub-system may operate as a means for allowing bi-directional communication between the various smart components in the environment; a sensory sub-system includes a plurality of sensors which may further allow the system to interact with the various smart components in the environment; and the control sub-system, which includes the central hub, allows for the controlling of the systems of the building or buildings in the environment, individually, or in combination with, for example, the sensor sub-system.

It shall be understood that the sub-systems may stand individually, or may be combined such that all sub-systems are simultaneously engaged. Further, it shall be understood that the distributed communications systems of multiple environments (e.g., buildings) may further be in communication with each other to send and receive relevant information. For example, sensors located on buildings along an entire block (or in a corporate park, neighborhood, street, etc.) may each be able to send and receive information to a central hub, which may aggregate the data for use as a collective whole.

The sub-systems are each now briefly described. The power sub-system provides power to the various smart components located within the building. For example, a window may be equipped with at least one source of power to provide electricity to the other various subsystems and devices which form a part of the overall system. In one embodiment, the window frame provides a housing for the power source such that it is invisible through the window. Power may be provided to the window frame via hard-wire cabling connected to a low-voltage power source in the building. Alternatively, the window and/or window frame may be equipped with solar-powered functionality, which may include a rechargeable battery for storing solar energy. In still another alternative, power to the frame may come from a battery source. Additional appropriate power sources may be recognized by those of ordinary skill in the art.

The power may be initially supplied to the frame, and then transferred from the frame to the various components making up a window system (e.g., sensors, controllers, etc.). In one embodiment of the invention, the frame receives power via a hard connection to a power source within the building, battery power, solar power, etc. The frame may then be used to supply power to other components. From the frame, the energy provided to the other components of the system may be transferred via a hard connection, such as an insulation displacement connector, sliding contacts, or plug connections with the frame. Alternatively, the energy may be supplied to the other components of the system via non-contact power, such as power remote sensing technology, in which the requirement for a hard connection is eliminated in favor of sensors which may transmit power and/or sensor signals across a gap between sensors. Other types of wireless power transfer, such as conductive power transfer and radiative and non-radiative power transfer may optionally be utilized.

In one embodiment of the invention, any wires which may be required to provide power to one or more components of the system may be located in the spacer of the window. The wires may be configured within the spacer such that the seal of the window is not disturbed. For example, the wires may be formed within the spacer (e.g., during the manufacturing process) such that power may be generally provided to and/or from the window frame if desired.

In another embodiment of the invention, it may be desirable to provide power and/or other transmission cables into the frame such that, for example, cable companies, internet companies, etc. may “plug into” the window frame from the outside of the building without requiring further access into the building. The services (e.g., cable, internet) may then be further distributed throughout the building, for example, through various communication systems described below.

Additionally, as described above, building components which may be located outside of a building may be able to access building power via the frame. Siding, shingles, and other building products, for example, could benefit from smart technology, as could other building products. Notably, siding is typically disposed on the outside of a building, and therefore receives sunlight throughout the day. As such, siding is uniquely positioned to receive environmental information and communicate such information to the other components within a building, as is described in greater detail herein. In buildings in which windows (and window frames) are plentiful, it may be possible for the edges of the siding to “plug into” the window frame to receive power. Alternately, the power may be distributed along a surface, such as a wall, as is described in greater detail in the examples below.

Moving on, the communications sub-system allows for bi-directional communication between the various components in, on, and around the building. The communication between the components and the hub may occur via a hard wired connection between the systems and sub-systems as may be necessary. Additionally, or alternately, the system may be equipped with means for wireless communication, for example, over a network or using Bluetooth technology, or using other wireless communication technologies currently existing or developed in the future which may be appropriate and adequate to accomplish the communication purposes herein.

For example, sensors and controls in a window may be configured for bi-directional communication, as described herein, such that information may be sent and received in a manner that allows for efficient and convenient control of system within the building. Information received by the window (or other receiving device) may be stored, for example, in any type of appropriate memory device associated with the system such that a building operator may review the information and take action as desired and/or necessary (e.g., via controls, as described above). Thus, the window may act as a sensor/receiver for receiving, storing, and transmitting information to and from the various components in communicative connection with the window. The window may be further in communication with the central hub, which may control operations of other components within the system as described herein.

In order to provide the controlled response, a plurality of sensors may be disposed in, on, or around a building which may optionally be connected to other components inside or outside of the building (e.g., via the central hub) to provide a complete sensor and response control loop. The sensors may receive power from the window frame as described above, or may alternately receive power by another means.

Sensors may be provided on any surface which may provide information about the environment. Sensors may be provided in, on, or between surfaces (e.g., walls, door frames, windows panes, door handles, on transparent surfaces such as glass surfaces, tempered glass surfaces, etc., shingles, siding, concrete, asphalt, etc.) which may be effective for gathering certain types of information. Sensors for detecting movement of particular environmental components may be provided. Additionally, sensors may be provided in door handles, which may be programmable to recognize the handprints of the various approved entrants into a building for security reasons. It shall be understood that these examples are exemplary in nature only and shall not be limiting.

In one embodiment, sensors for detecting harmful chemicals, odors, or biohazards may be disposed in locations around a building, for example, at or near the window frame. For example, sensors may be provided to detect the presence of a fire (for example, through smoke detection, as smoke travels to areas of low pressure near the windows), harmful gasses, such as carbon monoxide, carbon dioxide, etc., obnoxious odors, and biohazards. The sensors may be equipped with, for example, alarms to alert the building occupants of a problem. Alternately, the sensors may send the information to the central hub, which may activate the alarms and/or sprinklers, and may further cause the HVAC system to reverse course, causing the smoke inside the building to be pumped out of the building. In another embodiment, temperature sensors may be located at or near the window frame, to measure the temperature either inside or outside of the building. Still other sensors may be located on the outside of the building for measuring activity in or around the walls of the building. As will be described in greater detail below, sensors on the outside of the building may sense impacts and provide a controlled response to the exterior of the structure. For example, a coating on the siding (or other building material, such as the shingles) may be applied in order to alter the durometer (hardness) of the building material in response to an impact (or a potential impact) thereon, potentially preventing damage to the outside of the building.

It shall be understood that sensors may be utilized to measure and/or record any and all types of activity in and around the building. Many different sensors are contemplated within the scope of the invention for receiving and transmitting information to and from the system (or other receiving device). Therefore, a “sensor” may further include, for example, a camera or video recording device which may monitor the status of the building. In one embodiment, multiple video recording devices may be strategically positioned around a building. The video recording device may send video information, via the communications system, to a security monitoring system, and/or may transmit the recording to a long-term storage device (e.g., at the central hub). Alternately, the video recording device may be in communication (e.g., wired or wireless communication) with a security locking system via the central hub. Upon reaching a certain predetermined threshold (e.g., time stamp, length of suspicious activity, etc.) the central hub may cause the building locking mechanism to engage.

Time sensors or daylight sensors may be in communication with the central hub which may communicate with controls for managing the turning on and off of lights in a building. Further, noise sensors may additionally be provided which may operate in conjunction with noise cancellation devices via the central hub for limiting the amount of noise that may travel through, for example, a wall, window, etc. In another embodiment, a window, via a sensor provided therein (or thereon or therewith) may sense someone touching the window or may even sense the person's presence near the window outside the home. The sensor may communicate with the central hub, which may cause lights or flashes of LED lighting in response.

Still other types of sensors may include, for example, sensors to measure moisture content in the soil, or sensors that detect clogged gutters (e.g., by detection of water levels in the gutters). Information may be stored in the memory device of the central hub for review by the building operator such that appropriate action may be taken (e.g., cleaning out gutters, turning on or off the sprinkler system or decreasing the frequency of activation of the sprinkler system, etc.)

It shall be recognized that certain sensors may allow for transmittal of signals to effectuate automatic action of a particular system. For example, a sensor to measure moisture content may relay the moisture content to the central hub, which may further communicate a signal to the sprinkler system, causing the sprinkler system to act according to the information from the sensor (e.g., turn off if the moisture content is high, or provide additional water if the moisture content is especially low).

A temperature sensor may be located in or around a window frame so as to measure the outside temperature. Another sensor (or multiple sensors) may be located inside the building, measuring the inside temperature. The sensor(s) measuring the inside and outside temperatures may communicate information to the central hub. If the inside temperature meets a certain threshold (e.g., above 75 degrees F.), then the central hub may determine whether the outside temperature meets a certain threshold (e.g., above 65 degrees F. but below 75 degrees F.). If both sensors meet the thresholds defined for each particular sensor, then the central hub may communicate with, for example, the thermostat to turn the air up or down, as appropriate. Alternately, or additionally, the central hub may communicate with a control to raise or lower the window itself.

If desirable, a hygrometer sensor (or multiple hygrometer sensors) may be provided in order to measure the humidity in the air, either inside or outside of the building. As described immediately above, this information may be useful for modifying the thermostat and/or opening and closing of the window(s) in order to control the temperature and comfortable air quality inside the building.

In one embodiment of the invention, a window is provided with a removable transom. The transom may be configured to be detachably connected to, for example, the bottom edge of a window rail. For example, the transom may be equipped with clips that connect to corresponding clips on the window rail. Thus, the transom may become part and parcel of the window, and may therefore rise up and down with the window, as desired. As shall be understood by those having ordinary skill in the art, the window may be equipped with security features that allow the window to lock into various vertical positions. This may be beneficial for example, where a transom as described herein is connected to an existing window, thus causing the bottom window sash to be raised from its initial locked position. However, it shall be understood that the transom may be positioned at any appropriate location in the window.

Further, it shall be understood that the transom may be connected to the window sash, for example, though a locking mechanism that allows the transom to lock into the track in the sash. The window may thus be allowed to move independently of the transom, and the corresponding window rail may abut the transom. To prevent unwanted air from entering and/or escaping the building, a seal may be placed along the edge of the transom and/or window rail, as necessary.

The transom may include a plurality of louvers, the opening and closing of which may be effectuated automatically via the central hub in communication with mechanical controls, or manually effectuated by activating the mechanical controls. In one embodiment, the transom may be in communication with one or more sensors and/or controls, e.g., via the central hub, which may act to automatically control the opening and closing of the louvers. For example, temperature sensors may be provided to measure the temperature inside and outside of the building. If the sensors detect a threshold temperature differential between the inside and the outside (e.g., 10 degrees), the central hub may send a signal to cause the louvers to open or close, as appropriate. The sensors may be programmable to detect certain thresholds in which the louvers are not to be opened (e.g., temperatures below 65 degrees F. or above 80 degrees F.). Other sensors may additionally or alternately provide information and/or control capabilities to the transom sub-system. For example, sensors that determine humidity in the home. If the sensor detects an inside humidity level above a certain level and the humidity level outside is less, the sensors may send a signal causing the louvers to open. Still further, sensors that detect levels of smoke, harmful gasses, etc. either inside or outside the home may cause the louvers to open or close, as appropriate.

The louvers may additionally be remotely controlled by a user. For example, it may be preferable for the building operator to control opening and closing of the louvers as necessary or desired. Thus, by using a remote control, the louvers may be opened and closed. In one embodiment, it may be preferable for the louvers to be both automatically controlled and remote-controlled. The automatic functionality may be turned on and off depending on various factors, such as time of the year, building occupation (e.g., louvers may not be opened while no one is home), etc.

In view of the foregoing, it shall be clear to those of ordinary skill in the art that the sensors distributed around the building environment may be capable of sensing many different changes in the environment, events, etc. and may communicate with various controls in response, e.g., through the central hub, which may cause one or more actions to be taken.

As has been described in some detail above, the sensors may, in communication with controls via the central hub, operate to control various operations inside the building via input from a user (e.g., via one or more controllers) or via the sensing capabilities provided as part of the environment(s). As information is received, it may be stored in memory. Further, the information may be communicated (e.g., over a network) to the other corresponding systems and sub-systems in order to create or control response to the information.

Further, building operator(s) may be able to access the stored information from the central hub through the central hub itself, or a remote computing device such as a phone, tablet, or computer. The building operator may be able to control the various system components via the computing device by sending signals to the hub to cause action by one or more of the components in communication therewith.

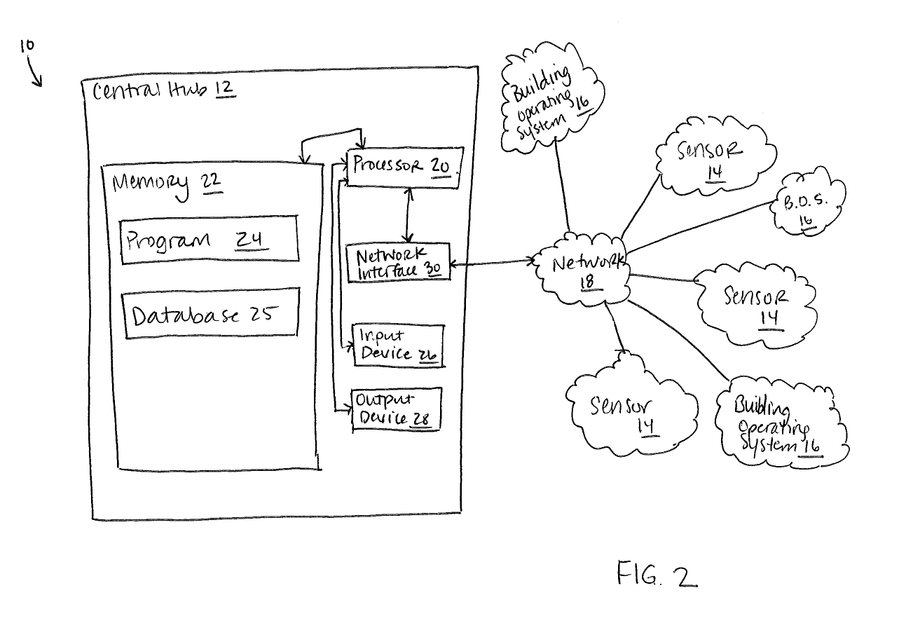

Referring now to FIG. 2, the central hub 12 may be embodied in a computer having associated therewith a processor 20 and a memory 22 housing algorithms (or programs) 24 directed generally to analyzing data from the various sensors 14 distributed throughout a building (or multiple buildings) and effectuating controlled response by the building operating systems 16 connected therewith. The central hub 12 may include input device(s) 26 (e.g., input keys, buttons, switches, etc.) and output devices(s) 28 (e.g., a display, a speaker, a warning light, etc.). The functionality of at least some of the input and output devices may be combined (e.g., as a display screen). The input devices 26 may further include the sensors 14 which may be in wired or wireless communication with the central hub. Further, the output devices 28 may be various building operating systems 16 (e.g., HVAC system, alarms, etc.) within the building which may be controlled through controls in communication with the central hub 12.

The computer 12 may be a desktop computer, a laptop computer, a smart phone, a tablet, a web or other server, etc. In embodiments, the computer may be a dedicated computing device adapted to send and receive data as part of a distributed communication system in line with the teachings of the present disclosure.

The processor 20 may be in further data communication with a network interface 30. The processor 20 represents one or more digital processors. Network interface 30 may be implemented as one or both of a wired network interface and a wireless network interface, as is known in the art. The input device 26 may include a keyboard, a mouse, a stylus pen, buttons, knobs, switches, sensors, and/or any other device that may allow a user to provide an input to the computer 12. In some embodiments, the input device 26 may comprise a media port (such as a USB port or a SD or microSD port) to allow for media (e.g., a USB drive, a SD or micro SD drive, a laptop memory, a smart phone memory, etc.) to be communicatively coupled to the computer 12. The output device 28 may include one or more visual indicators (e.g., a display), audible indicators (e.g., speakers), building components 16 (e.g., HVAC system, alarms, mechanically operated windows, smart building materials, etc.) or any other such output device now known or subsequently developed. In some embodiments, at least a part of the input device 26 and the output device 28 may be combined. A user may functionally interact with the distributed control system 10 through the central hub 12, using the input device 26 and the output device 28.

Memory 22 represents one or more of volatile memory (e.g., RAM) and non-volatile memory (e.g., ROM, FLASH, magnetic media, optical media, etc.). Although shown within the structure, memory 22 may be, at least in part, implemented as network storage that is external to the structure and accessed via the network interface 30. The memory 22 may house software 24, which may be stored in a transitory or non-transitory portion of the memory 22. Software 24 includes machine readable instructions that are executed by processor to perform the functionality described herein. In some example embodiments, the processor 20 may be configured through particularly configured hardware, such as an application specific integrated circuit (ASIC), field-programmable gate array (FPGA), etc., and/or through execution of software (e.g., software) to perform functions in accordance with the disclosure herein.

The software 24 may include instructions for receiving information from sensors 14 distributed throughout the building(s), analyzing the data, and sending a signal to effectuate a controlled response by one or more of the distributed communication system components 16. The software 24 may be programmable by a user according to the user's preferences (e.g., regarding temperature, humidity, amount of desired sunlight, etc.).

In one embodiment, building operating system components 16 of the distributed communication system 10 may include building materials such as siding, sheet rock, etc. The building operating systems 16 traditionally do not include building materials. However, as mentioned herein, building materials are often uniquely positioned to be able to receive information, often due to placement of the materials and interaction with the building environment. One such material that is in constant contact with the outside environment is siding on a building. Traditionally, siding is constructed of wood or a hard plastic. The ability to use the siding as part of a distributed communication system (e.g., system 10) has not yet been realized. However, because of its proximity to the outside environment, which ultimately has an effect on almost all systems within a building, it would be beneficial to incorporate the siding into the distributed communication system as described below.

While some examples provided herein are specific to certain types of building products, it shall be understood by those of skill in the art that other building materials may be manufactured or retrofitted in order to have communication and responsive capabilities, and is contemplated within the scope of the invention.

Building owners often select siding based on two main criteria: the type of material the siding is made of, and the color of the siding. Vinyl siding may be selected based on its durability and ease of installation. Because it is so durable, once vinyl siding is installed on a building, it may not need to be replaced for a long time, as warranties for vinyl siding can range for 20 to 40 years. This also makes vinyl siding very economical. One downside, however, is that once the siding is installed, the owner may not be able to change his or her mind on the color for several years. If the building owner makes a poor decision, s/he may be stuck.

One possible solution is a coating configured to selectively change colors in response to an external stimulus. The coating may be, for example, a liquid resin having microscopic beads dispersed therein. The beads may be tunable based on an external stimulus, such as an electric or magnetic field, which acts upon the resin. Activation of the external stimulus may cause reorientation of the beads, which may change the perceivable color of the coating. The intensity of the external stimulus may be increased or decreased to influence the beads to provide multiple apparent color options.

Recently, the University of California, Riverside developed a polymer material that has polymer beads that change color instantaneously upon activation of an external magnetic field. The polymer beads or “magnetochromatic microspheres” change orientation when the external magnetic field acts upon the microspheres, causing an apparent color change. Surprisingly, the intrinsic properties of the microspheres remain virtually unchanged. Embedded arrays of magnetic iron oxide nanostructures within each microsphere enables user to “switch” the colors by merely changing the orientation of the microsphere. The microstructures can similarly be arranged in periodic arrays, which allow larger surfaces to be influenced. The use of external stimulus allows for near instant change in orientation, and may be easily integrated into current devices that are already in the market.

Another example of a coating is described in U.S. patent application Ser. No. 15/365,923, which is incorporated herein by reference in its entirety. As described therein, the coating may include a plurality of nanoparticles dispersed in a media, such as an adhesive or resin. The nanoparticles may be composed of, for example, fullerene, graphene (e.g., in a rolled 3D structure), or other type of electrically or magnetically influenced particle. When suspended in a media, the coating may take the form of a ferrofluid, for example, which exhibits magnetic properties in the presence of a magnetic field.

The benefits of such coatings may be greater than simply changing color, however. In U.S. application Ser. No. 15/365,923, it is described that the durometer (or hardness) of the coating may be manipulated by applying an electric or magnetic field. By orienting the nanoparticles in a particular direction, for example, the coating may be able to dampen forces that are received by a material that is covered in the coating. By changing the durometer of a material, such as a coating, via external stimulus, it may be further possible to effectively influence the reflection/refraction properties of the material. By changing the reflection/refraction properties, the apparent color may be apparently changed, but would not be necessary.

In one embodiment of the invention, a distributed communications system for incorporation into various building materials, includes a coating having a plurality of microspheres (or nanoparticles, as the case may be) dispersed therein. The microspheres may be electrically or magnetically persuadable in response to an external electric or magnetic stimulus.

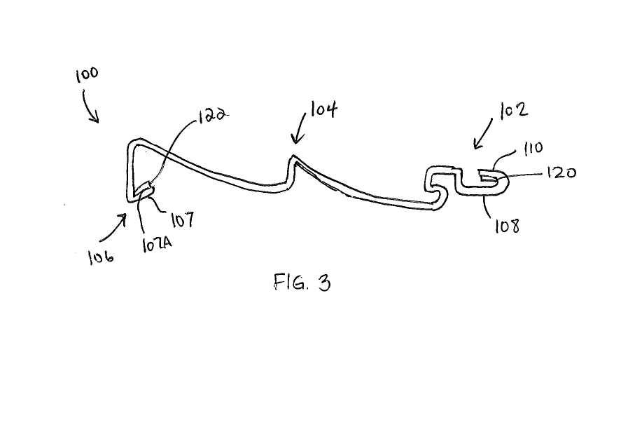

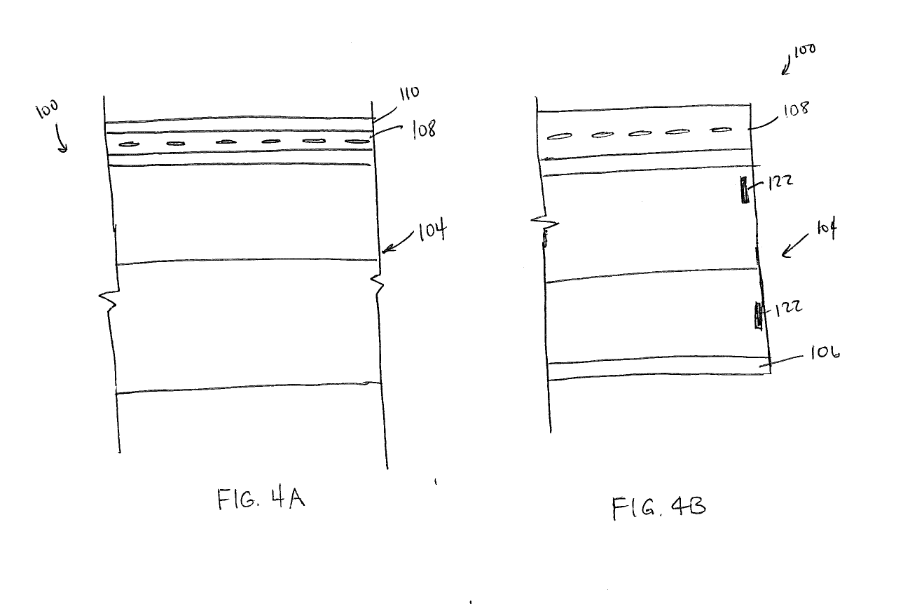

For purposes of discussion herein, the coating is described as a being provided on siding. However, it shall be understood by those of skill in the art that the coating may be used on any type of material or substrate which may be integrated into the distributed communications system described herein. FIGS. 3, 4A, and 4B illustrates a side view of a piece of vinyl siding 100, similar to what is provided in the market today. Each piece of siding includes an upper attachment member 102 and a lower attachment member 106 with a central portion 104 disposed therebetween. The upper attachment member 102 includes a nail flange 108 extending away from the central portion 104 to allow attachment of the piece of siding to the building. The upper attachment member 102 may further include a male snap portion 110, which may be received by the lower attachment member 106, forming a female snap portion 107.

Traditionally, to install the siding 100 on the side of a building, a first piece of siding is positioned on the wall and secured thereto by nailing the siding 100 to the wall via the nail flange 108. Once the first piece of siding is in place, a second piece of siding may be mated with the first piece by inserting the male snap portion 110 of the first piece into the female snap portion 107 of the second piece. The second piece may then be secured to the wall by nailing the siding to the wall via the nail flange 108. This process is continued until the entire wall is covered.

The siding of the present invention may be secured to the wall in a similar manner. Here, however, the siding may be coated as described above, and may be further configured to be able to provide magnetic or electrical stimulus to the coating on the siding. For example, the male snap portion 108 may be provided with a strip of conductive material 120. Likewise, an inside edge 107A of the female snap portion 107 may be provided with a strip of conductive material 120. When the edge of the male snap portion 108 having the strip of conductive material comes into contact with the edge of the female snap portion 107 having the strip of conductive material, it may complete the circuit, allowing an electric or magnetic stimulus to be provided along the mated edge of the siding.

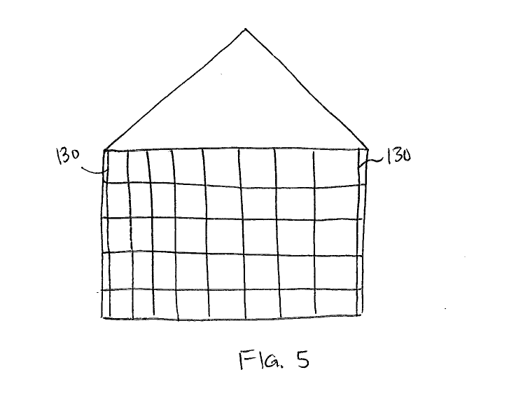

The end edges of the siding 100 may additionally include one or more contact members 122 which may come into contact with, for example, an electrical lead 130 positioned at the corner of the building (see FIG. 5). It may be desirable for electrical leads to be placed at each corner of the building. The strip of conductive material may be wrapped around the edge of the siding or otherwise configured such that it comes into contact with the lead, allowing electricity to transfer from the electrical lead across the conductive material.

The electrical lead may be a wire (e.g., muscle wire) that carries electricity along the outside of the building. The electrical lead may be wired into the power source of the building. In one embodiment, the lead may be attached to a battery, which may be powered via solar power or other harvested power (e.g., stored power from vibrational energy or temperature differential across a predetermined surface). Accordingly, the coating may be controllable without requiring the use of additional electricity. When the electricity is turned on, it may flow from the electricity source through the lead wire, and subsequently through the strip of conductive material.

The strength of an electric field is dependent on the distance between the source of the electric field and the location where the electric field is measured. In other words, the magnitude decreases as the distance from the source increases. Accordingly, the coated siding that is located closer to the electrical energy source may experience a greater electrical field than siding that is farther away. In embodiments, this may be desirable, as the natural decrease in electrical field strength may lay down a pattern across the distance of the siding.

However, in embodiments, it may be preferred for the siding to have a uniform appearance. As the pieces of siding may be electrically connected together via the strips of conductive material as described above, it may be possible, or even desirable, to control the coating of an entire wall (or even building) at one time. The electricity may be equally distributed through the lead wires, e.g., through the strategic use of resistors, and further across the conductive material on the pieces of siding. The orientation of all particles distributed in the coating and electrically connected as described herein may thus be easily controlled.

As the electricity flows from the lead wires across the conductive material 120 and 122, the particles in the coating may respond accordingly. The particles may respond differently to the intensity of the electric field. Further, the particles may respond to electric fields flowing from one direction to another (e.g., from areas of negative charge to areas of positive charge). For example, electrical waveform patterns moving from left to right may cause the particles in the coating to align in a certain fashion which causes specific reflective or refractive response which may be desirable for certain environmental conditions (e.g., excess sunlight, darkness, etc.) Likewise, electrical waveform patterns moving from right to left may effect a different change. Still further, electrical waveform patterns moving from top to bottom may cause a particular effect on the particles in the coating. The direction and intensity of the electrical field may thus be adjusted as necessary via a building's operations manager or through automatic communication with other subsystems distributed throughout the building as described in greater detail below. As is known to those of skill in the art, an electrical signal can be cause to “move” in a certain direction by signal daisy-chain repeaters, signal bridges, network switches, multiplexers, shift register stages, etc.

In other embodiments, it may be desirable for sections of the siding to be controlled separately from others. Different areas in a building often have different requirements, thereby requiring unique treatment. Accordingly, it may be possible to activate an electric or magnetic field at particular areas of the siding. The electrical leads may be placed in a grid pattern, for example, on a side of a building (see FIG. 5). Here, conductive material may additionally (optionally) be located along the back edge of the nail flange, or may even cover the entire back surface of the siding. As the siding is placed on the building, it may come into contact with multiple electrical leads at different points along the side of the building. Because electricity may be flowing through the leads along different paths, the particles distributed between the leads may be influenced by the various electricity paths acting as stimulus for the particles. For example, leads may be placed both horizontally and vertically along the wall. Particles may be influenced by the flow of electricity in two directions.

In still another embodiment, a backing layer, such as a wire mesh, may be provided behind the siding (or other substrate). Control of the electricity flowing through the wire mesh may allow the particles in the siding itself to be controlled as well. Here, the electric field in the wire mesh may be sufficient to persuade movement of the particles without a need for additional conductive material. Similar to the electrical leads described above, the wire mesh may be electrically connected into the electrical system within the building. Alternately, the mesh may be self-powering, e.g., via solar panels, which may be used to charge batteries which may provide the necessary power.

Preferably, the power requirement of the coating remains relatively low. In an “off” state, electricity does not flow through the electrical components of the system, and the particles in the coating may be configured to rest in a position that provides a pale or neutral color and has an acceptable durometer. Ideally, in a resting position, the particles are aligned such that the apparent color of the coating is uniform across a building. When electricity is applied to the system, the particles will align according to the direction and magnitude of the electrical field as described herein.

The electric field may be selectively activated by a user, which may be able to control the magnitude of the electric field, e.g., via the central hub. It shall be understood by those of skill in the art that the hub may be controlled itself, or it may be remotely controlled (e.g., through the use of a cellular phone or other wireless control device). The hub may initiate the electric field across the entire system, or selectively across portions of the system as desired. As sections of the system may be selectively activated and controlled, the apparent color of the sections may be manipulated in order to display patterns or images. For example, in a building having several floors, it may be possible to control the orientation of the particles on alternate floors such that the building appears striped. During national holidays, the applied electrical field may cause the particles to reflect/refract in such a way that a flag appears on one or more sides of the building.

Alternately, in embodiments and as briefly noted above, the siding may be tied into the distributed communications system 10 of the building to control operation of the siding 100 and/or other components of the system. For example, one or more temperature sensors inside the building may measure the indoor temperature of the building. The temperature data may be transmitted (e.g., through wireless or wired transmission) to the computer 12 which, through programming 24, may determine whether the indoor temperature is above a predetermined threshold value. If the temperature is above the predetermined threshold value, then the computer 12 may send a signal to activate the electric or magnetic field causing the reorientation of the particles in the coating of the siding 100 to change the apparent color. For example, if the temperature is higher than the predetermined threshold value, then the electric or magnetic field may cause orientation of the particles such that the apparent color is lighter, or more reflective, e.g., tan, light blue, etc., such that the sunlight is not converted into heat. However, if the temperature is lower than the predetermined threshold value, then the electric or magnetic field may cause orientation of the particles such that the apparent color is darker, e.g., dark blue, black, etc., such that the light is converted into heat (which may in turn help to heat the building). The temperature of the inside of the building can thus be controlled.

In one embodiment, the user may be able to override the automatic manipulation of the electric field by the distributed communications system 10 via the central hub 12. For example, if an image or pattern is preferred, the user can temporarily disable the ability of the distributed communications system 10 to automatically control the electric field applied to the coating (e.g., via sensors 14). Optionally, the override may be provided on a timer such that the distributed communications system automatically resumes control of the applied electric field (e.g., the central hub may be set to display a flag from 12:00 a.m. local time to 11:59 p.m. local time on July 4, and then may automatically resume automatic control thereafter).

The coating may be selectively activated in response to environmental changes outside of the building as well. As noted herein, the durometer (or hardness) of the coating may be manipulated by increasing and decreasing the magnitude of the electrical field applied thereto. By altering the durometer of the coating, the siding may be able to perform better in certain environmental situations. For example, in hurricanes, it may be preferable for the durometer of the coating to be increased such that the siding is hardened. As debris contacts the side of the building, significant damage may be avoided. Here, the electricity requirements of the system may be higher in order to maintain the particles in the correct position to allow for increased durometer. Incidentally, when the durometer of the coating changes, so does its reflective/refractive properties, thereby having an apparent color-changing effect. However, in many environmental conditions, it may not be necessary to have such extreme coating properties. Accordingly, the durometer may be based on the preferred color of the siding, rather than the properties that the coating supplies to the siding.

In one embodiment, proximity sensors may be located at or near one or more sections of a building. The proximity sensors may be further configured to communicate with, for example, a handheld wireless device that may be used by a person near the building. The user may have stored on the wireless device or in one or more applications (e.g., Facebook) one or more preferences (e.g., consumer brands, sports teams, music, authors, etc.). As the person approaches a building having the coating system applied thereto, the proximity sensors may sense that the person is nearing the building, and may request preference information from the wireless device. The wireless device may communicate to the sensors that the person follows a particular sports team and has a taste for Diet Coke. The sensors may automatically communicate this information to the hub. In response, the hub may cause the system to output a certain pattern of electricity in order to affect a particular image commensurate with the person's preferences. Here, the Diet Coke logo may be displayed on the side of the building. Optionally, the logo may travel (e.g., move across the building) as the person moves from one side to another.

Companies may desire to provide selective advertising which may be used with a person's preferences as described above. Here, a business may provide an advertisement which may be stored in a database 25 of the hub 12. Advertisers may pay money according to a fee schedule to the owner of the hub to ensure that the advertisement is played when a person having a preference for a particular product approaches a building. Multiple advertisements may optionally be displayed at a time, according to the person's preferences.

Other sensors may additionally (or alternately) be placed at or near the siding 100. The sensors may be configured to sense impacts or movement of the siding. When the sensor senses an impact, the magnitude of the impact may be communicated to the central hub 12, which may analyze the impact and subsequently activate the flow of electricity through the lead wires 130. Those of skill in the art shall understand that the communication of information from the sensors to the control hub 12 and the subsequent activation of the flow of electricity through the lead wires may occur in real time, and substantially instantaneously.

In embodiments, the coating may take the form of a paint, which may be applied to one or more building materials, such as sheet rock or flooring. The coating may again be controllable by an electric field which may be applied across the wall (e.g., from left to right, top to bottom, etc.). Here, a wire mesh may be applied to the wall before the paint coating. Alternately, in this embodiment and other embodiments described herein, a magnetic field may be created by running electricity though wires disposed along the length of a wall or the floor. The application of the magnetic field may cause the particles to be repositioned, thereby causing an apparent color change in the paint.

In an embodiment where the coating is applied to flooring, the particles may have a tendency to align in such a way that the surface is perceivable as being smooth. The application of an electrical or magnetic field may cause the particles to align in such a way that the surface becomes gritty, providing an anti-skid surface. This may be particularly useful where sensors 16 may determine that liquid has been spilled onto an area of the floor. An electrical or magnetic field may be applied in that area to cause a change in the material properties, which may prevent people from slipping on the wet surface.

In still another embodiment, coated surfaces may be self-cleaning. The electrical or magnetic field may be applied in vibrational patterns that may cause the coating to vibrate (preferably imperceptibly (e.g., ultrasonic vibrations)), for example, during rain storms, to persuade dirt off of the siding. This may be useful in siding applications, among others, as well.

The coating may further be able to serve as a monitor of the health of the building material to which it is applied. For example, the particles (e.g., piezo elements) may be able to sense impacts upon a surface and transfer (e.g., over the network 18) information about those impacts to the hub 12 such that the health of building material may be monitored. The particles may even be equipped with a read-write memory mode, which may allow the particle to store information in memory concerning the building material to which it is applied. That information may be transmitted, e.g., over the network 18, to the hub 12. The building material can thus be monitored remotely. Such real-time monitoring may be useful for managing the life of the building material by alerting the building owner to potential issues in the material before complete failure of the material. This may even help to extend the life of the building material.

In still a further embodiment, materials used outside of the building itself may incorporate the coating described in U.S. application Ser. No. 15/365,923. For example, the coating may be applied to the surface of a parking lot. In still another embodiment, the coating may be formulated as a binder which may be mixed in with asphalt which may be applied as the parking lot, floor, sidewalk, etc.

Heretofore, the sensors were separate and apart from the coating material. However, in embodiments, the sensors may be embodied in the coating itself. Here, the particles may be configured to operate in mixed mode, dual mode or multiplexed mode which allows the programmable material particles to be used as sensor, passive mechanical damping elements and active dynamic controlled response elements simultaneously or at different discrete periods in time. The advanced features provided and enabled by multi-mode particle operation can allow a particular or particle group to perform sensory functions and provide dynamic controlled response. Some particles may operate in sensor mode all of the time while others can be selectively switched to a dynamic controlled response mode based on distributed communication and or system programming and profiled parameters. In still other advanced modes such as a closed loop tuned mode, a particle or group of particles can be excited by a varying waveform and may also monitor the variations of applied force distortion as a sensor indication of error offset feedback. In these embodiments, a particle is operational as a sensor and control device at the same time. The error offset feedback is monitored as a sensor input and can be waveform cancelled in order to provide enhancements to the control signal which in turn can be used to reduce distortion to the desired controlled response of the overall system. One example of a particle that can support mixed mode functions is a piezo element, which can be used as both an output annunciator and a displacement sensing transducer simultaneously.

Many different arrangements of the described invention are possible without departing from the spirit and scope of the present invention. Embodiments of the present invention are described herein with the intent to be illustrative rather than restrictive. Alternative embodiments will become apparent to those skilled in the art that do not depart from its scope. A skilled artisan may develop alternative means of implementing the disclosed improvements without departing from the scope of the present invention.

Further, it will be understood that certain features and subcombinations are of utility and may be employed without reference to other features and subcombinations and are contemplated within the scope of the claims. Not all steps listed in the various figures and description needs to be carried out in the specific order described. The description should not be restricted to the specific described embodiments.

1. A distributed communications system, comprising:
a substrate coated with a coating comprising a plurality of particles dispersed therein, the particles being tunable in response to an electric stimulus applied to the substrate;
a sensor distributed near the substrate; and
a central hub in communication with the sensor and the substrate, the central hub being embodied in a computer structure having non-transitory computer readable medium with computer executable instructions stored thereon executed by a digital processor to:
analyze data received by the sensor;
determine a magnitude of the electric stimulus based on the data received by the sensor; and
activate the electric stimulus.

2. The distributed communications system of claim 1, wherein the substrate is at least one of siding, shingles, and flooring.

3. The distributed communications system of claim 2, wherein the sensor is selected from the list consisting of: a temperature sensor, a pressure sensor, a proximity sensor, and a motion sensor.

4. The distributed communications system of claim 2, wherein the substrate is siding secured to an exterior wall of a building, each piece of siding comprising:
an upper attachment member;
a lower attachment member;
a central portion disposed between the upper attachment member and the lower attachment member; and
a strip of conductive material disposed to a portion of a back face of the piece of siding,
wherein the conductive material interfaces with electrical leads on the building to provide electrical stimulus to the siding.

5. The distributed communications system of claim 4, wherein the electrical stimulus is applied in a waveform pattern.

6. The distributed communications system of claim 1, wherein activation of the electric field causes a change in the color of the coating.

7. The distributed communications system of claim 1, wherein activation of the electric field causes a change in the durometer of the coating.

8. The distributed communications system of claim 1, wherein the particle is the sensor.

9. A distributed communications system, comprising:
a substrate;
a sensor on the substrate; and
a central hub in communication with the sensor and the substrate, the central hub being embodied in a computer structure having non-transitory computer readable medium with computer executable instructions stored thereon executed by a digital processor to:
analyze data received by the sensor relating to a change of a property of the substrate; and
provide an output to effectuate a change in a property of the substrate.

10. The distributed communications system of claim 9, wherein the output effectuates a change in a property of the substrate that is different than the change of a property of the substrate received by the sensor.

11. The distributed communications system of claim 9, wherein the substrate is a window equipped with a plurality of louvers that rotate from an open position to a closed position.

12. The distributed communications system of claim 11, wherein the sensor is a temperature sensor.

13. The distributed communications system of claim 12, wherein the output causes the louvers to rotate from the open position to the closed position and vice versa.

14. A distributed communications system, comprising:
a central hub in communication with a sensor disposed at a first location and a building operating system disposed at a second location, the central hub being embodied in a computer structure having non-transitory computer readable medium with computer executable instructions stored thereon executed by a digital processor to:
analyze data received by the sensor of environmental conditions at a first time at the first location;
make a prediction of environmental conditions at a second time at the second location; and
activate a response by the building operating system according to the prediction;
wherein the first location and the second location are not within a single structure.

15. The distributed communications system of claim 14, wherein the sensor is a temperature sensor, and wherein the response by the building operating system is to adjust the temperature at the second location.

16. The distributed communications system of claim 14, wherein the sensor is an earthquake sensor and wherein the building operating system is an alarm, the building operating system activating an alarm at the second location in response to the data received by the earthquake sensor.
